(19) United States
(12) Patent Application Publication
(10) Pub. No.: US 2026/0064661 A1
(43) Pub. Date: Mar. 5, 2026

(54) SESSIONLESS TRANSACTIONS

(71) Applicant: Oracle International Corporation, Redwood Shores, CA (US)

(72) Inventors: Natesha Kedlaya, Cupertino, CA (US); Wuh-Chwen (Sven) Hwang, Belmont, CA (US); Sukhada Shashank Pendse, Foster City, CA (US); Kevin S. Neel, San Mateo, CA (US); Nancy R. Ikeda, Los Altos Hills, CA (US); Swamy Prasanna Jenukal Siddeshwara, Bengaluru (IN); Ajit Mylavarapu, Mountain View, CA (US)

(21) Appl. No.: 19/191,157

(22) Filed: Apr. 28, 2025

Related U.S. Application Data
(60) Provisional application No. 63/688,762, filed on Aug. 29, 2024.

(51) Int. Cl. G06F 16/23

(52) U.S. Cl. CPC G06F 16/2365; G06F 16/2379

(57) ABSTRACT

Techniques for processing “Sessionless” transactions are provided. In one technique, a commit transaction instruction (that includes a transaction identifier) is received from a requesting entity at a first instance of a database server. In response a prepare message is transmitted to a second instance of the database server. A response that indicates that the second instance successfully performed an action in response to the prepare message is received from the second instance based on the prepare message. After the response is received, a transaction that is identified by the transaction identifier is committed. A response, to the commit transaction instruction, that indicates that the transaction is committed is transmitted to the requesting entity. Other techniques include piggybacking transaction instructions with database operation instructions and allowing different database server instances to perform work for a single transaction.

### BENEFIT CLAIM

This application claims benefit under 35 U.S.C. § 119 (e) of provisional application U.S. Ser. No. 63/688,762, filed Aug. 29, 2024, by Natesha Kedlaya et al., the entire contents of which are hereby incorporated by reference.

### TECHNICAL FIELD

The present disclosure relates generally to database transactions and, more specifically, to multiplexing transactions between database sessions and connections.

### BACKGROUND

Oracle database offers many efficient resource usage features and solutions like Connection pooling (Oracle UCP and OCI Connection pooling), Session Pooling (Client and Database, resident connection pooling), Shared server configuration, and CMAN-TDM. These solutions offer efficient database resource utilization for non-transactional workloads. Once transactions are incorporated into the workload, the connection and session resources are tightly coupled with the transactions and are released only after the transactions are ended. This holds up valuable server-side resources, especially if applications have a large think time for performing complex calculations in the application, or if transactions are long-running. Ideally, such applications should grab a session from the database, submit a unit of work, release the session, attend to the complex logic, grab another session, resume the transaction, submit another unit of work, and in the end commit the transaction. This ability is powerful and yet missing in databases today.

In addition, stateless protocols such as REST are becoming popular in modern applications. Oracle REST Data Services (ORDS) provides a bridge between modern applications and Oracle Database. However, with a lack of the session/connection multiplexing capability with the transactions, ORDS requires one to write predefined endpoints using PL/SQL procedures where the applications need to declare the entire transaction logic in the endpoint, limiting interactive behavior. Also, requiring application developers to write and store procedures on the server-side limits flexibility in being able to make changes to application logic solely on the client-side. Furthermore, even with the benefits of technologies like ORDS, it is not possible to combine multiple REST calls into a single transaction.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example database usage architecture, in an embodiment;

FIG. 2 is a block diagram that depicts an example set of sessions pertaining to a “Sessionless” transaction, in an embodiment;

FIG. 3 is a block diagram that depicts how XA transactions and Sessionless transactions may be implemented by a middleware platform;

FIG. 4 is a diagram that depicts a first set of roundtrips with a database system involving a traditional XA transaction contrasted with a second set of roundtrips with a database system involving a Sessionless transaction, in an embodiment;

FIG. 5 is a flow diagram that depicts an example process for piggybacking transaction instructions on a database instruction, in an embodiment;

FIG. 6 is a flow diagram that depicts an example process for performing two-phase commit, in an embodiment;

FIG. 7 is a block diagram that illustrates a computer system upon which an embodiment of the invention may be implemented;

FIG. 8 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### XA Transactions

Enterprise applications may enlist external Transaction Managers (TMs) to guarantee completion of a series of operations in transactional Resource Managers (RM), such as Oracle Database. Examples of TMs include Tuxedo, Web Logic Server, and BEA. Typically, external TMs use Extended Architecture Transactions (or XA Transactions) to group a series of operations from several transactional RMs into a single reliable global transaction. Oracle XA Transactions based on the XA open standard allows one to multiplex transactions between connections and sessions. The XA open standard defines a series of interfaces between external TMs and local transactional RMs. Using those interfaces, external TMs can reliably coordinate a 2-phase commit protocol to order the sequence of operations across multiple RMs running on multiple servers. The XA protocol also defines APIs to suspend and resume the local transactions at the RMs.

However, despite the benefit of multiplexing transactions between connections and sessions, a prerequisite for using XA transactions is to deploy external TMs. Also, there are several disadvantages with XA transactions. First, there is high transaction latency when resource managers (RMs) (such as databases) are slow or the network between the external TMs and the RMs is unreliable. External TMs are not database native and are separately licensed. Second, an XA transaction is only as reliable as the external TM itself even though the individual RMs may be highly available and reliable, such as Oracle Database. Third, even when a multi-instance RAC (real application cluster) database is considered as a single RM, external TMs cannot suspend and resume transactions across RAC database instances. TMs are forced to create and manage branches across RAC database instances. Also, this feature puts the burden of load balancing across RAC instances to the applications. Fourth, TMs need to run two-phase commit between the branches created across the RAC database instances. This type of commit incurs significant latency.

### General Overview

A system and method for decoupling database sessions from database transactions are provided. Such a type of transaction is referred to herein as a “Sessionless” transaction. For an application that interacts with a database server, this means that a transaction can be suspended using a newly added interface and resumed, at a later point in time, in a different session on the database server. Suspending a transaction not only releases the server-side session resources, but also releases connection resources, thus enabling independent scaling of transactions and sessions. Moreover, database-level locks continue to be held across a suspend operation relative to a transaction, so that on subsequent resumption of the transaction, the application does not have to perform any validation checks. This provides stateless behavior for interacting with the database, without the complexities of optimistic concurrency control.

Embodiments improve computer-related technology pertaining to database transactions. Such technical improvements include efficient session/connection resource utilization. Embodiments also include a single command to commit a transaction (rather than multiple commands). Such embodiments comprise a new internalized commit protocol that needs only one client server round trip and, thus, improves the commit performance. Embodiments also provide native mechanisms to start, suspend, and resume a transaction on any server instance in a cluster and, in the end, commit or rollback such a transaction from any server instance. Also, embodiments mean that external transaction managers (TMs) do not need to keep track of branches to specific database servers (or nodes) in a server cluster because the database servers interact with each other to resume and commit transactions.

Embodiments also eliminate external TMs in single resource manager (RM) (e.g., single database system) scenarios. Thus, a client application may communicate with an RM directly because the RM handles session management and a two-phase commit protocol, removing, for the client application, complexities that the external TMs handled. Also, the XA protocol is no longer necessary. However, embodiments provide interfaces to promote a transaction into an XA transaction so that users can still enjoy the XA protocol's extensibility if transaction guarantee across heterogeneous RMs is needed.

### System Overview

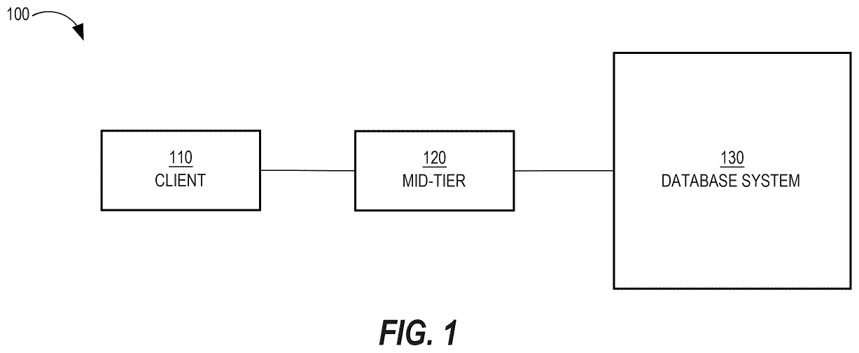

FIG. 1 is a block diagram that depicts an example database usage architecture 100, in an embodiment. Database usage architecture 100 comprises a client 110, a mid-tier 120, and a database system 130. In a related embodiment, database usage architecture 100 does not include mid-tier 120, in which case client 110 is communicatively coupled to database system 130 without an intermediary that accepts and translates requests from client 110. Although only a single client 110 is depicted, other embodiments may include multiple clients that are communicatively coupled to database system 130, whether directly or indirectly through mid-tier 120.

Client 110 is an application that executes business logic and that requests (directly or indirectly through mid-tier 120) database system 130 to perform one or more database operations, such as a read operation or a write operation. Examples of write operations include an insert operation, a delete operation, and an update operation. Client 110 executes on a computing device, which may be remote relative to database system 130 and even mid-tier 120. For example, client 110 may implement HTTP/IP to communicate with mid-tier 120. Client 110 may include a client driver that is configured to transmit transaction-related requests that are expected by mid-tier 120 and/or database system 130.

Mid-tier 120 comprises one or more computing devices that accept requests from client 110 and translate those requests into database requests that database system 130 is configured to read and process. Mid-tier 120 receives responses to those database requests and forwards the responses to client 110. Mid-tier 120 hides the complexity of database system 130 so that client 110 is not required interact directly with database system 130.

In an embodiment, mid-tier 120 comprises one or more microservices that client 110 leverages to perform work that client 110 requests.

### “Sessionless” Transaction

A “Sessionless” transaction is one that is able to be multiplexed between database sessions and connections with database system 130. A Sessionless transaction relies on native mechanisms to start, suspend, and resume the transaction and, in the end, commit or rollback the transaction. A Sessionless transaction is identified by a transaction identifier (ID). A transaction ID may originate from the entity that is communicating with database system 130 or from database system 130 itself. For example, client 110 includes a transaction ID in a request that includes a start transaction instruction or a resume transaction instruction, regardless of whether mid-tier 120 is an intermediate between client 110 and database system 130. As another example, where mid-tier 120 is involved, mid-tier 120 generates a transaction ID and includes the transaction ID in a request that includes a start transaction instruction or a resume transaction instruction. As another example, database system 130 receives (from client 110 or from mid-tier 120) a request that includes a transaction instruction but does not include a transaction identifier. This lack of a transaction identifier is an implied request for a transaction ID. A lack of a transaction ID also indicates that the request is a request to start a transaction. In response to receiving the request, database system 130 generates a unique transaction ID that is globally unique, with respect to database system 130. Once a transaction that is associated with a transaction ID is committed, that transaction ID may be reused later for a future transaction that database system 130 manages.

A Sessionless transaction comprises two sets of database statements: a first set of database statements that is executed or processed before a suspension of the Sessionless transaction, and a second set of database statements that is executed or processed after a resumption of the Sessionless transaction. A Sessionless transaction may comprise additional sets of database statements.

In an embodiment, a Sessionless transaction provides two capabilities for users of database system 130. One capability is suspending a Sessionless transaction after completion of one or more database statements. When a Sessionless transaction is suspended, database system 130 releases database session resources, such as memory that stored state of the connected user information and physical connections. Transaction states (or changes performed by the transaction) are stored in database system 130. The database session resources that were released can then be used by other concurrent users/applications to do other work. Decoupling a transaction from a session means that the same session may be used to do other work when this transaction is not actively modifying data in database system 130.

Another capability is resuming a Sessionless transaction in a new session. If database system 130 comprises a cluster of nodes, then the new session may be brought up on a node that is different than the node on which the Sessionless transaction was suspended. In fact, the “new” node may be selected for resuming the Sessionless transaction based on the current load of each node in the cluster. Thus, such suspension and resuming of a Sessionless transaction allows for load balancing. Otherwise, if such suspension and resuming were not allowed, then the node on which the Sessionless transaction is executing may become overloaded when the second set of database statements is processed.

The completion of one or more database statements before a suspend instruction or before a commit instruction is referred to as a “unit of work.” Database system 130 may perform, for example, a first unit of work between a start instruction and a suspend instruction, a second unit of work between a resume instruction and a suspend instruction, and a third unit of work between a resume instruction and a commit instruction is a unit of work. Thus, each Sessionless transaction may comprise two or more units of work. Each unit of work may involve multiple messages that are transmitted between a requesting entity (e.g., client 110 or mid-tier 120) and database system 130. For example, client 110 (or its client driver) sends a first message that includes a start transaction instruction, one or more first database operation instructions, and, optionally, a transaction ID. Database system 130 starts a transaction, assigns session resources to the transaction and performs one or more database operations as instructed in the one or more first database operation instructions. Client 110 then sends a second message that includes one or more second database operation instructions, but no transaction ID. Because the two messages are coming in on the same network connection with database system 130, database system 130 associates the second message with the first message, which means that the second message is for the same transaction. After client 110 sends a suspend transaction instruction, whether in the second message or in a third message, database system 130 is said to complete a unit of work. Database system 130 suspends the transaction and releases the session resources to be used by another transaction.

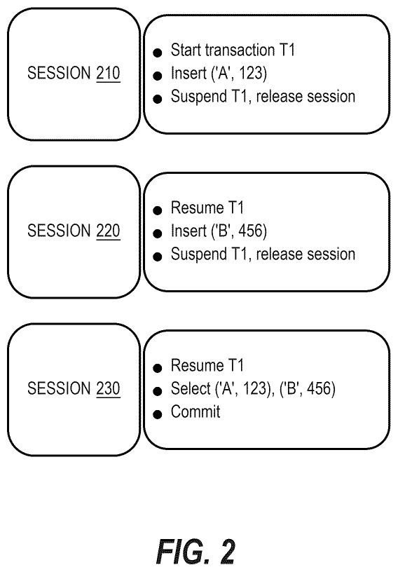

FIG. 2 is a block diagram that depicts an example set of sessions pertaining to a Sessionless transaction, in an embodiment. In this example, a user/application uses three sessions to initiate performance of a set of operations: sessions 210-230, each of which comprises three instructions. Session 210 comprises a start transaction instruction (where the Sessionless transaction has a transaction identifier of “T1”), an insert instruction, a suspend transaction instruction, and a release session instruction. The insert instruction may be in the form of a database statement, such as an INSERT statement in SQL. Session 220 comprises a resume transaction instruction (which, when executed, causes the corresponding session to be attached to the specified transaction and causes the Sessionless transaction to be resumed), an insert instruction, a suspend instruction, and a release session instruction. Session 230 comprises a resume transaction instruction, a select instruction, and a commit instruction. The select instruction may also be in the form of a database statement, such as a SELECT statement in SQL. For example, a user/application grabs session 210 from a session pool and includes the four instructions as part of session 210. Since the user/application does not immediately need to do more work, the user/application releases session 210 back to the session pool, allowing other users/applications to use that session to perform some work. Later, the user/application determines to perform additional work and grabs another session (i.e., session 220), initiating four more instructions.

If database system 130 comprises a cluster of nodes, each node executing a different instance of a database server, then each of these three sessions 210-230 may be stored on a different node of the cluster.

In an embodiment where mid-tier 120 implements REST data services, users can: (1) decompose large endpoint handlers into smaller, generic handlers; (2) write complex, interactive logic natively in client 110 between decomposed endpoint requests; and (3) load balance requests to different nodes or server instances of database system 130. For example, before Sessionless transactions, an endpoint handler written in logic of client 110 is the following:

```
Endpoint0_Handler {
  Begin
    if (condition)
      statement1
    else
      statement2
  commit
  End
}
Request to Endpoint0
```

In contrast, with Sessionless transactions, multiple smaller endpoint handlers may be composed:

```
Endpoint1_Handler
{ statement1 }
Endpoint2_Handler
{ statement2 }
if app-specific condition:
  Request to Endpoint1
else:
  Request to Endpoint2
```

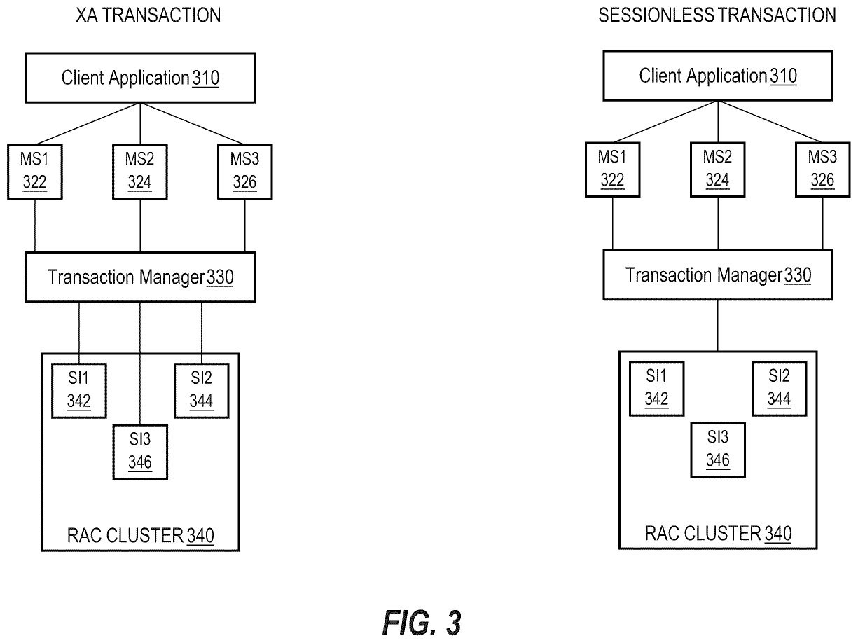

In one scenario, mid-tier 120 implements a middleware platform (e.g., Tuxedo) that is used to manage distributed transaction processing in distributed computing environments. In such a scenario, different database statements of a transaction may be sent to different nodes (executing different servers) in a cluster of servers. FIG. 3 is a block diagram that depicts how transaction managers operate in a microservice environment implementing the XA protocol and implementing embodiments described herein. On the left side of FIG. 3, different microservices (MS1 322 to MS3 326) may receive and process requests from client application 310. An external transaction manager 330 (e.g., that implements MicroTx) creates a branch for each new node, of a cluster, on which an XA transaction executes. Thus, if an XA transaction was managed by four different server instances (SIs) of RAC cluster 340, then transaction manager 330 maintains four different sets of branch information. Also, transaction manager 330 coordinates the 2-phase commit protocol. If the coordinator on transaction manager 330 dies, then recovery may be relatively complex.

In contrast, in an embodiment with Sessionless transactions, as depicted on the right side of FIG. 3, transaction manager 330 manages a single Sessionless transaction, where there is no need for the XA protocol. Thus, there is no need for transaction manager 330 to manage branch information for multiple branches, since such branches are unnecessary with Sessionless transactions. Furthermore, transaction manager 330 is not required to coordinate the 2-phase commit protocol. Consequently, there is no need for a complex recovery mechanism. The block diagram of FIG. 3, on the right side, depicts how a Sessionless transaction used by a middleware platform does not involve multiple branches, in an embodiment.

There are two main types of transactions: global and local. A global transaction is a transaction that is associated with a GTRID (or global transaction identifier). For example, a global transaction is one that spans across multiple microservices or that involves a single microservice interacting with multiple resource managers (RMs). Thus, a global transaction requires coordination to ensure data consistency across all involved parties. In contrast, a local transaction is one that interacts with only one resource manager, such as a single database. Also, a local transaction is one that is not associated with a GTRID.

In an embodiment, a local transaction is also a Sessionless transaction. The local transaction may involve just a client application (that is initiating the local transaction) and a database system or may also involve a mid-tier component in between the client application and the database system. A Sessionless transaction makes starting, suspending, resuming, and committing transactions relatively simple because the work of managing sessions and transaction state is performed all by the database system rather than the client application or a mid-tier component. Whichever component is interacting with the database system (whether the client application or a mid-tier component), that component views (or interacts with) the database system as a single entity, even though the database system comprises multiple server instances that independently handle transaction-related requests, sessions, and transactions. The server instances communicate with each other to retrieve transaction state and resume transactions that were suspended on other server instances. The entity interacting with the database system simply needs a transaction identifier to uniquely identify the transaction to the database system. The interacting entity does not need to manage branches (or connections) to different server instances of the database system. Therefore, the interface with the database system changes with this embodiment.

In a scenario involving multiple mid-tier components, each with their own transaction manager (TM), current approaches for managing transactions require that the client application communicate with the same mid-tier component (and, thus, the same TM) for a single transaction. However, in an embodiment, a Sessionless transaction allows any of the mid-tier components to start, suspend, resume, and commit a transaction. For example, a client application transmits transaction instructions to a first mid-tier transaction component, which initiates a Sessionless transaction on a first instance of a database server of a database system. The first mid-tier component sends a suspend transaction to the first instance, which suspends the Sessionless transaction and allows the session resources to be released to be used by, for example, one or more other transactions executing on the first instance. Later, the client application transmits the transaction identifier of the Sessionless transaction (and database instructions) to a second mid-tier component, which communicates transaction instructions (including the transaction identifier and a resume transaction) to a second instance of the database server. In response to receiving the transaction instructions and the transaction identifier, the second instance obtains a session for this Sessionless transaction, resumes the Sessionless transaction, and performs one or more database operations in the context of this Sessionless transaction.

### Piggybacking Transaction Instructions

In an embodiment, one or more transaction instructions accompany (or “piggyback” on) a message that includes a database instruction, such as an insert or delete instruction. Example transaction instructions include a start transaction instruction, a detach or suspend instruction, a resume instruction, and a commit instruction. The message that includes both types of instructions (i.e., transaction instructions and database instructions) may originate from client 110 or from mid-tier 120. By piggybacking one or more transaction instructions with a database instruction, latency with database system 130 is significantly reduced.

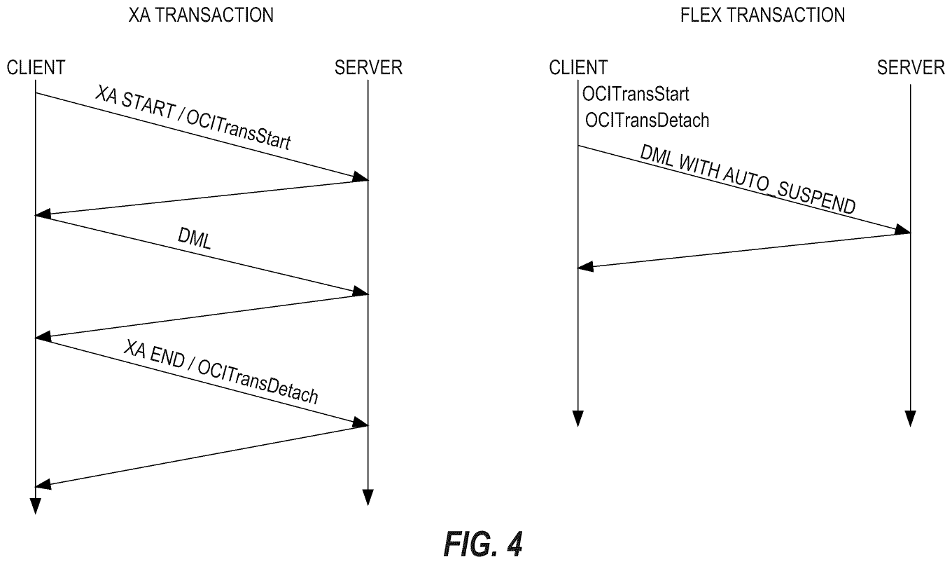

FIG. 4 is a diagram that depicts a first set of roundtrips with a database system involving a traditional XA transaction contrasted with a second set of roundtrips with a database system involving a Sessionless transaction, in an embodiment. This diagram depicts that, with XA transactions that are implemented based on the XA protocol, the client (e.g., application or external TM) must wait for a response from the server for each transaction instruction to finish before issuing, to the server, a database operation instruction or the next transaction instruction. In contrast, with Sessionless transactions, multiple transaction instructions may be piggybacked on a database operation instruction.

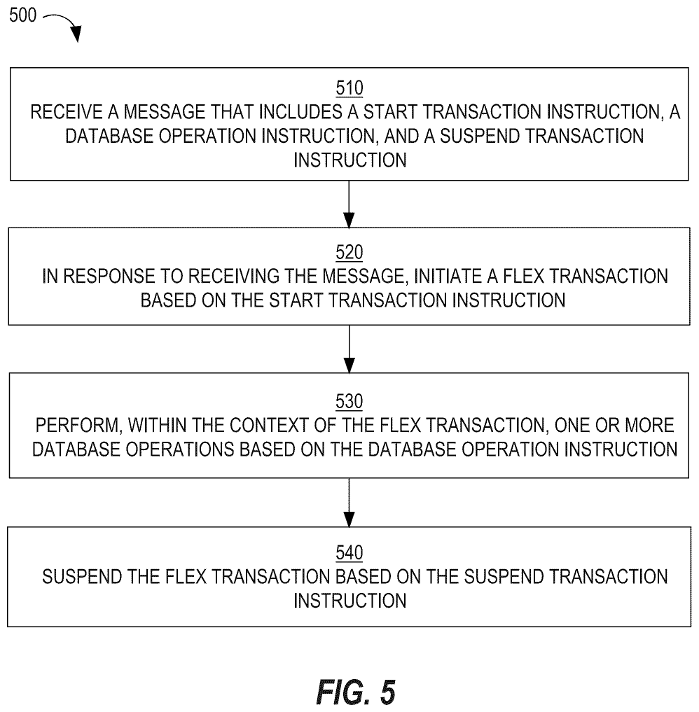

FIG. 5 is a flow diagram that depicts an example process 500 for piggybacking transaction control instructions on a database operation instruction, in an embodiment.

At block 510, a database server (of database system 130) receives a message (e.g., from client 110 or mid-tier 120) that includes a start transaction instruction, a database operation instruction, and a suspend transaction instruction. The message may also include a transaction identifier that uniquely identifies the (e.g., local) transaction, at least with respect to other transactions from the sender of the message.

At block 520, in response to receiving the message, the database server initiates a (e.g., local) Sessionless transaction based on the start transaction instruction. The Sessionless transaction is associated with the transaction identifier.

At block 530, the database server performs, within the context of the Sessionless transaction, one or more database operations based on the database operation instruction. For example, the one or more database operations may involve one or more insert operations and one or more delete operations.

At block 540, the database server suspends the Sessionless transaction based on the suspend transaction instruction. When database operations are performed within the context of Sessionless transaction (block 530), persistent storage stores data that this transaction has not yet committed. At the time of suspension, there is no need to persist additional data indicating the transaction state. Block 540 involve a detach operation, which frees up the session to be used by other work.

Process 500 may proceed with another client-based message that includes a resume transaction instruction, a database operation instruction, and either another suspend transaction instruction or a commit transaction instruction.

### Internal Two-Phase Commit

According to the XA protocol, in order to commit a transaction that has existed on multiple instances of a database server at different points in time, a client must send a prepare message to each of those instances and wait for a response from each of those instances. Once the client receives responses from those instances, the client then sends a commit message to at least one of the instances and waits for a response that the commit occurred. In other words, in the XA protocol, the client or external TM must drive the commit protocol, incurring several roundtrips to the server.

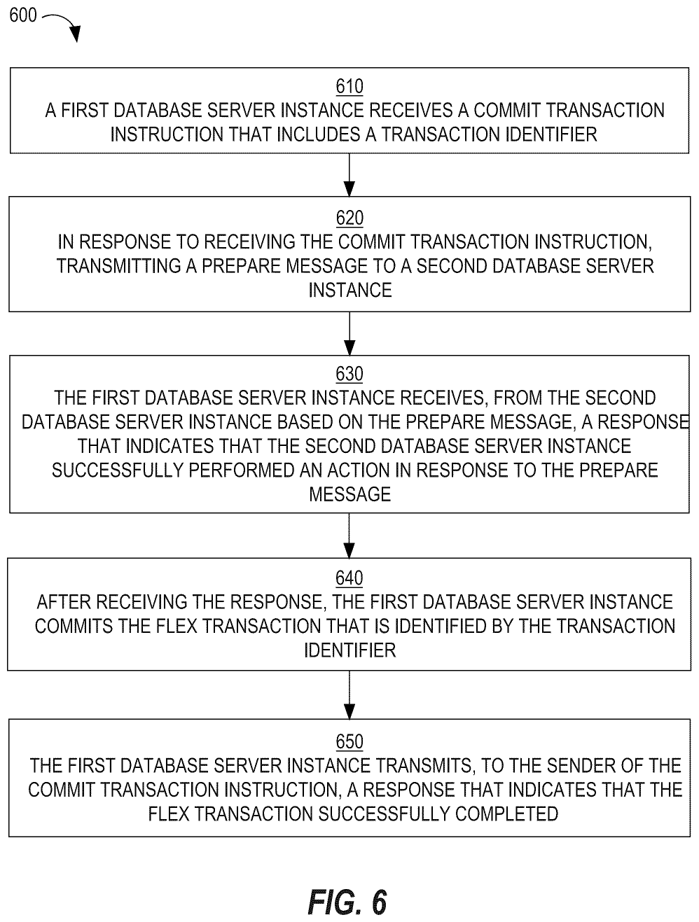

In contrast, in embodiments, a Sessionless transaction requires a single commit message (and no prepare message) from the client and that commit message may be transmitted to any instance. Thus, only a single roundtrip between the client and server is required. FIG. 6 is a flow diagram that depicts an example process 600 for performing an internal two-phase commit, in an embodiment.

At block 610, a first instance of a database server (of database system 130) receives a commit transaction instruction that includes a transaction identifier. The commit transaction instruction originates from client 110 or mid-tier 120. The commit transaction instruction may be part of a message that includes a resume transaction instruction and a database operation instruction.

At block 620, in response to receiving the commit transaction instruction, the first instance transmits, to a second instance of the database server, a prepare message. The prepare message includes the transaction identifier so that the recipients know which Sessionless transaction is to be committed. The prepare message causes any changes of the Sessionless transaction to be stored in persistent storage along with data that indicates that the Sessionless transaction is prepared. Block 620 may involve transmitting a prepare message to one or more other instances of the database server. In a related embodiment, block 620 involves the first instance determining which other instances of the database server “held” the Sessionless transaction and only sending the prepare message to those instances.

If the commit transaction instruction in block 610 accompanied a resume transaction instruction and a database operation instruction, then block 620 may be preceded by a resume transaction operation (where the first instance attaches a new session to the Sessionless transaction) and by one or more database operations that are executed in the context of Sessionless transaction.

At block 630, the first instance receives, from the second instance based on the prepare message, a response that indicates whether the second instance successfully performed an action in response to the prepare message. The action may be the successful persistent storage of the changes made by the Sessionless transaction. If the first instance does not receive an indication of a successful performance by the second instance (e.g., not receiving a response from the second instance within a certain period of time or the response from the second instance indicates that the action was not successfully performed), then the first instance will roll back the Sessionless transaction and then notify the sender of the commit transaction instruction that the Sessionless transaction has been rolled back.

At block 640, after receiving the response of successful performance, the first instance commits the Sessionless transaction that is identified by the transaction identifier. Block 640 may involve storing any changes that have been made by the first instance based on the Sessionless transaction in persistent storage. The location of these changes may be the same non-volatile location where other instances stored changes made by the Sessionless transaction on the corresponding cluster nodes.

At block 650, the first instance transmits, to the sender of the commit transaction instruction, a response that indicates that the Sessionless transaction successfully committed.

In an embodiment, a first server instance receives a request that includes a commit transaction instruction and a resume transaction instruction. Executing the resume transaction instruction causes the first server instance to send, to one or more other server instances, a message to retrieve, from another (e.g., the original) server instance, all the necessary information that is needed to resume the transaction and, optionally, perform one or more database operations (e.g., according to a database operation instruction included in the request). Such inter-instance communication is very fast and does not substantially increase latency of processing a transaction-related request. In this way, the two-phase commit protocol is not necessary because all the transaction data (including any changes initiated by the transaction) is stored on the first server instance. This embodiment is useful in planned maintenance scenarios to allow server instances to shut down while a transaction continues. Thus, if it is determined that a particular server instance is to be shut down (e.g., for a software upgrade), then the particular server instance will transmit, to one or more other server instances, transaction data pertaining to one or more transactions. Thereafter, the other server instances are able to respond to resume transaction instructions for those one or more transactions.

### Server Instance Agnosticism

As described herein, current approaches require that a requesting entity manages branches with server instances in a cluster of nodes in order to remember where messages pertaining to a single transaction should be sent. In an embodiment, which server instance messages related to a transaction is no longer important, as long as the server instances are connected to the same database and support inter-instance communication. In this embodiment, a requesting entity (e.g., a client application or a mid-tier component) may send, to different server instances, different units of work pertaining to a single transaction. Each unit of work comprises one or more messages.

A first server instance starts a Sessionless transaction based on a message from a requesting entity, assigns the Sessionless transaction to a session for the requesting entity, performs one or more database operations based on the same or different message from the requesting entity, suspends the Sessionless transaction based on the same or different message from the requesting entity, and releases the session. A different transaction may be assigned to the session, while the Sessionless transaction is suspended (i.e., not complete). The first server instance creates and stores a record that indicates the one or more database operations and/or a description of the work that was performed when performing the one or more database operations.

Later, a second server instance (that is different than the first server instance, but in the same cluster as the first server instance) resumes the Sessionless transaction based on a message from the requesting entity. The message includes a transaction ID. The second server instance assigns the Sessionless transaction to the session from which the requesting entity sends requests.

Data pertaining to a Sessionless transaction may be categorized into two parts: the actual record (the database operations/description of the work performed) and the metadata. Each server instance, when working on the same Sessionless transaction, generates a set of (undo) records; that is, one set of records per server instance per Sessionless transaction. A set of records can be uniquely identified by an identifier. Records are stored to persistent storage, which is shared across multiple server instances. On the other hand, the metadata is shared across all database instances in a database server cluster. The metadata may be titled “Sessionless txn <its transaction ID>” and has a list of identifiers to the transaction's sets of records. Thus, all participating server instances know what sets of records constitute this Sessionless transaction.

Sharing of this metadata may be performed in one of multiple ways. For example, each server instance implements a cross-instance synchronization tool that allows metadata of a Sessionless transaction to be passed to each server instance, one server instance at a time. Each inter-instance request for the metadata of a Sessionless transaction includes the transaction ID, which is used by the receiving server instance to determine whether it stores data about the corresponding Sessionless transaction. In this example, the first server instance determines that it stores metadata about the corresponding Sessionless transaction and transmits that metadata to the second server instance.

When resuming a Sessionless transaction on a server instance that has not worked on the Sessionless transaction before, the server instance obtains the metadata (using the cross-instance synchronization tool) and appends, to the metadata of the Sessionless transaction, an identifier of a set of records that the server instance generates. Records of database operations/description of the work performed goes to that set of records.

The second server instance performs one or more database operations based on the same message (which included a resume transaction instruction) or a different message from the requesting entity. The second server instance either suspends or commits the Sessionless transaction, which would be based on a transaction instruction in a message from the requesting entity. The second server instance then releases the session.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

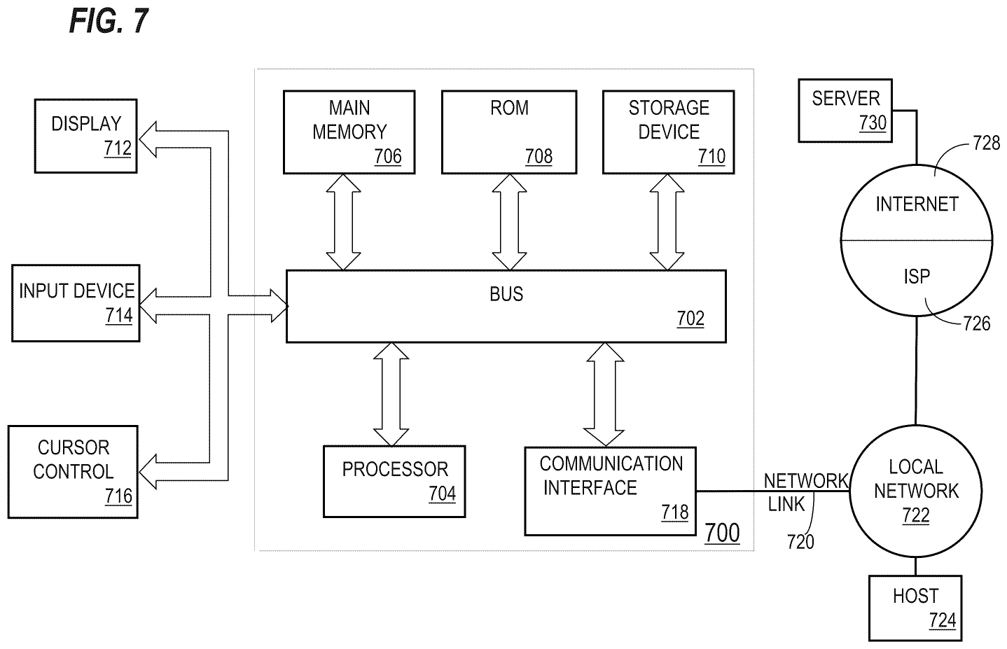

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

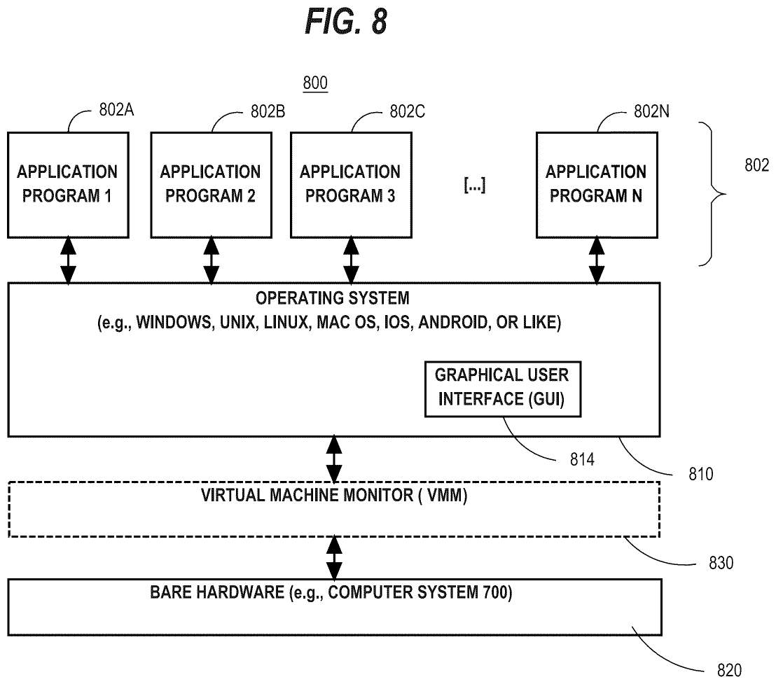

FIG. 8 is a block diagram of a basic software system 800 that may be employed for controlling the operation of computer system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computer system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from a requesting entity, at a first instance of a database server, a commit transaction instruction that includes a transaction identifier;
in response to receiving the commit transaction instruction, transmitting, to a second instance of the database server, a prepare message;
receiving, from the second instance based on the prepare message, a response that indicates that the second instance successfully performed an action in response to the prepare message;
after receiving the response, committing a transaction that is identified by the transaction identifier;
transmitting, to the requesting entity, a response, to the commit transaction instruction, that indicates that the transaction is committed;
wherein the method is performed by one or more computing devices.

2. The method of claim 1, further comprising:
in response to receiving the prepare message, the second instance identifying state of the transaction and causing the state of the transaction to be stored persistently in a database.

3. The method of claim 1, wherein the commit transaction instruction, a start transaction instruction, a suspend transaction instruction, or a resume transaction instruction is included in a message that includes a database operation instruction.

4. The method of claim 3, further comprising, prior to transmitting the prepare message:
resuming the transaction based on the resume transaction instruction;
performing, as part of the transaction, one or more database operations based on the database operation instruction.

5. A method comprising:
receiving, at a database server, a message that includes a database operation instruction and a local transaction instruction;
in response to receiving the message:
performing an operation with respect to a local transaction based on the local transaction instruction;
performing one or more database operations based on the database operation instruction;
wherein the method is performed by one or more computing devices.

6. The method of claim 5, wherein the local transaction instruction is one of a start transaction instruction, a suspend transaction instruction, or a resume transaction instruction.

7. The method of claim 6, wherein the transaction instruction is the start transaction instruction, the method further comprising:
in response to receiving the message, transmitting a response that indicates that the transaction indicated by the transaction identifier has been started and that the one or more database operations were performed successfully.

8. The method of claim 6, wherein the transaction instruction is the suspend transaction instruction, the method further comprising:
after suspending the transaction, transmitting, in response to receiving the message, a response that indicates that the transaction successfully suspended and that the one or more database operations were performed successfully.

9. The method of claim 8, further comprising:
receiving, at the database server, a second message that includes the transaction identifier that identifies the transaction, a resume transaction instruction, and a second database operation instruction;
in response to receiving the second message:
resuming the transaction based on the resume transaction instruction;
performing one or more second database operations based on the second database operation instruction.

10. The method of claim 9, wherein the message is a first message:
the first message was received at a first instance of the database server;
the second message was received at a second instance, of the database server, that is different than the first instance.

11. The method of claim 5, further comprising:
after transmitting a response to the first message, receiving, at the database server, a second message that includes a transaction identifier that identifies the transaction, a second database operation instruction, and a commit transaction instruction;
in response to receiving the second message:
performing one or more second database operations based on the second database operation instruction;
committing the transaction based on the commit transaction instruction.

12. The method of claim 7, wherein the one or more database operations include an insert operation, an update operation, or a delete operation.

13. A method comprising:
based on receiving one or more first messages at a first database server instance:
starting a transaction;
identifying a transaction identifier for the transaction;
performing one or more first database operations;
suspending the transaction;
based on receiving one or more second messages at a second database server instance that is different than the first database server instance:
identifying the transaction identifier in one of the one or more second messages;
performing one or more second database operations based on a result of performing the one or more first database operations;
wherein the method is performed by one or more computing devices.

14. The method of claim 13, further comprising, prior to performing the one or more second database operations:
sending, by the second database server instance, to the first database server instance, a request that includes the transaction identifier;
receiving, from the first database server instance, data about the transaction.

15. The method of claim 13, wherein the one or more first messages are a plurality of messages that includes (1) a first message that includes a start transaction instruction and (2) a second message that includes a suspend transaction instruction.

16. The method of claim 13, wherein the one or more second messages are a plurality of messages that includes (1) a first message that includes a resume transaction instruction and the transaction identifier and (2) a second message that includes a database operation instruction.

17. The method of claim 13, wherein the one or more first messages is a single message that includes (1) a start transaction instruction and (2) a second message that includes a suspend transaction instruction.
